(19) United States
(12) Patent Application Publication
(10) Pub. No.: US 2017/0192973 A1
(43) Pub. Date: Jul. 6, 2017

(54) SYSTEM AND METHOD FOR RECOMMENDING TRENDING CONTENT BASED ON CONTEXT

(71) Applicant: Cortica, Ltd., TEL AVIV (IL)

(72) Inventors: Igal Raichelgauz, New York, NY (US); Karina Odinaev, New York, NY (US); Yehoshua Y. Zeevi, Haifa (IL)

(73) Assignee: Cortica, Ltd., TEL AVIV (IL)

(21) Appl. No.: 15/463,414

(22) Filed: Mar. 20, 2017

Related U.S. Application Data
(63) Continuation-in-part of application No. 13/770,603, filed on Feb. 19, 2013.
Application No. 13/770,603 is a continuation-in-part of application No. 13/624,397, filed on Sep. 21, 2012, now Pat. No. 9,191,626.
Application No. 13/624,397 is a continuation-in-part of application No. 13/344,400, filed on Jan. 5, 2012, now Pat. No. 8,959,037.
Application No. 13/344,400 is a continuation of application No. 12/434,221, filed on May 1, 2009, now Pat. No. 8,112,376.
Application No. 13/624,397 is a continuation-in-part of application No. 12/195,863, filed on Aug. 21, 2008, now Pat. No. 8,326,775.
Application No. 12/195,863 is a continuation-in-part of application No. 12/084,150, filed on Apr. 7, 2009, now Pat. No. 8,655,801.
Application No. 13/624,397 is a continuation-in-part of application No. 12/084,150, filed on Apr. 7, 2009, now Pat. No. 8,655,801.
(60) Provisional application No. 62/310,743, filed on Mar. 20, 2016.

(30) Foreign Application Priority Data
Oct. 26, 2005 (IL) 171577
Jan. 29, 2006 (IL) 173409
Aug. 21, 2007 (IL) 185414

(51) Int. Cl. G06F 17/30

(52) U.S. Cl. CPC G06F 17/30038; G06F 17/30867; G06F 17/30873

(57) ABSTRACT

A system and method for recommending trending content based on context. The method includes receiving a query, wherein the query indicates a user intent; searching in at least one data source for a plurality of multimedia content elements related to the user intent; generating at least one signature for each of the plurality of multimedia content elements, wherein each signature represents a concept, wherein each concept is a collection of signatures and metadata describing the concept; correlating the concepts of the generated signatures to determine at least one context of each multimedia content element, wherein each context represents a sentiment; and generating, based on the determined contexts, a recommendation of at least one multimedia content element from among the plurality of multimedia content elements.

### CROSS-REFERENCE TO RELATED APPLICATIONS

This application claims the benefit of U.S. Provisional Application No. 62/310,743 filed on Mar. 20, 2016. This application is also a continuation-in-part of U.S. patent application Ser. No. 13/770,603 filed on Feb. 19, 2013, now pending, which is a continuation-in-part (CIP) of U.S. patent application Ser. No. 13/624,397 filed on Sep. 21, 2012, now U.S. Pat. No. 9,191,626. The Ser. No. 13/624,397 Application is a CIP of:

(a) U.S. patent application Ser. No. 13/344,400 filed on Jan. 5, 2012, now U.S. Pat. No. 8,959,037, which is a continuation of U.S. patent application Ser. No. 12/434,221 filed on May 1, 2009, now U.S. Pat. No. 8,112,376;

(b) U.S. patent application Ser. No. 12/195,863 filed on Aug. 21, 2008, now U.S. Pat. No. 8,326,775, which claims priority under 35 USC 119 from Israeli Application No. 185414, filed on Aug. 21, 2007, and which is also a continuation-in-part of the below-referenced U.S. patent application Ser. No. 12/084,150; and,

(c) U.S. patent application Ser. No. 12/084,150 filed on Apr. 25, 2008, now U.S. Pat. No. 8,65,801, which is the National Stage of International Application No. PCT/IL2006/001235, filed on Oct. 26, 2006, which claims foreign priority from Israeli Application No. 171577 filed on Oct. 26, 2005, and Israeli Application No. 173409 filed on Jan. 29, 2006.

All of the applications referenced above are herein incorporated by reference.

### TECHNICAL FIELD

The present disclosure relates generally to the analysis of multimedia content displayed in web-pages, and more specifically to identifying trends of multimedia content displayed in web-pages.

### BACKGROUND

Content uploaded to web platforms plays an increasingly significant role in people's lives. The web platforms may include, for example, social networks, videos, talkbacks, chat, news feeds, and so on. Such web platforms allow users to communicate and share content with other users. Some web platforms monitor trending content that is viewed by a relatively large number of users to provide the trending content to other users in, e.g., a “Trending Topics” or similar list. For example, “viral videos” may be videos uploaded to, for example, YouTube® or other web platforms which are viewed a large number of times. Moreover, trendiness of content may be based on feedback (e.g., “likes,” shares, etc.) from other users.

As a large amount of content is uploaded by many users every day, it has become more difficult for content providers to stand out even when their content becomes popular. As a result, high quality or otherwise notable content may not be viewed, even by users that would otherwise be interested in the content. Further, as the feedback from other users is not necessarily provided in real-time, it is highly difficult to track the trendiness and the effect of a post or content such as images uploaded by a user.

It would therefore be advantageous to provide a solution that overcomes the deficiencies noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for recommending trending content based on context. The method comprises: receiving a query, wherein the query indicates a user intent; searching in at least one data source for a plurality of multimedia content elements related to the user intent; generating at least one signature for each of the plurality of multimedia content elements, wherein each signature represents a concept, wherein each concept is a collection of signatures and metadata describing the concept; correlating the concepts of the generated signatures to determine at least one context of each multimedia content element, wherein each context represents a sentiment; and generating, based on the determined contexts, a recommendation of at least one multimedia content element from among the plurality of multimedia content elements.

Certain embodiments disclosed herein also include a non-transitory computer readable medium having stored thereon causing a processing circuitry to execute a process, the process comprising: receiving a query, wherein the query indicates a user intent; searching in at least one data source for a plurality of multimedia content elements related to the user intent; generating at least one signature for each of the plurality of multimedia content elements, wherein each signature represents a concept, wherein each concept is a collection of signatures and metadata describing the concept; correlating the concepts of the generated signatures to determine at least one context of each multimedia content element, wherein each context represents a sentiment; and generating, based on the determined contexts, a recommendation of at least one multimedia content element from among the plurality of multimedia content elements.

Certain embodiments disclosed herein also include a system for recommending trending content based on context, comprising: a processing circuitry; and a memory, the memory containing instructions that, when executed by the processing circuitry, configure the processing circuitry to: receive a query, wherein the query indicates a user intent; search in at least one data source for a plurality of multimedia content elements related to the user intent; generate at least one signature for each of the plurality of multimedia content elements, wherein each signature represents a concept, wherein each concept is a collection of signatures and metadata describing the concept; correlate the concepts of the generated signatures to determine at least one context of each multimedia content element, wherein each context represents a sentiment; and generate, based on the determined contexts, a recommendation of at least one multimedia content element from among the plurality of multimedia content elements.

### BRIEF DESCRIPTION OF THE DRAWINGS

The disclosed subject matter is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a flowchart illustrating a method for recommending trending content based on context.

FIG. 3 is a block diagram depicting the basic flow of information in the signature generator system.

FIG. 4 is a diagram illustrating the flow of patches generation, response vector generation, and signature generation in a large-scale speech-to-text system.

FIG. 5 is a block diagram of a trending content recommendation generator according to an embodiment.

FIG. 6 is a flowchart illustrating a method for determining a context of multimedia content elements according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

Various embodiments disclosed herein allow for recommending trending content. The trending content may be, for example, multimedia content elements that are popular on web sources such as social media and content repository sites. In an embodiment, a query is received. The query may be a textual query, a multimedia content element, or a portion thereof indicating a user intent of a user. The intent may indicate subject matter of content sought by the user.

A plurality of web sources is searched through for multimedia content elements associated with the user intent. At least one signature is generated for each multimedia content element determined to be related to the user intent. Each of the generated signatures represents a concept, which is an abstract description of the content to which the signature was generated. Correlations among the concepts are determined. Respective of the correlation, a context of each found multimedia content element is determined. A recommendation is generated based on the determined contexts.

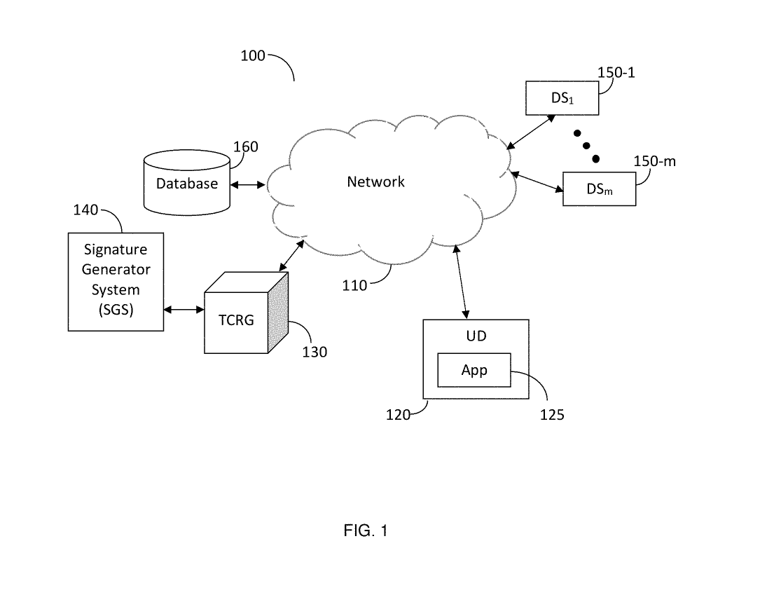

FIG. 1 shows a network diagram 100 utilized to describe the various disclosed embodiments. The example network diagram 100 includes a user device 120, a trending content recommendation generator (TCRG) 130 (hereinafter referred to as a recommendation generator 130, merely for simplicity purposes), a signature generator system (SGS) 140, a plurality of data sources 150-1 through 150-m (hereinafter referred to collectively as data sources 150 or individually as a data source 150, merely for simplicity purposes), and a database 160, communicatively connected via a network 110. The network 110 may be, but is not limited to, the Internet, the world-wide-web (WWW), a local area network (LAN), a wide area network (WAN), a metro area network (MAN), and other networks capable of enabling communication between the elements of the network diagram 100.

The user device 120 may have installed thereon an application 125 such as, but not limited to, a web browser. The user device 120 may be, but is not limited to, a personal computer (PC), a personal digital assistant (PDA), a mobile phone, a smart phone, a tablet computer, a wearable computing device and other kinds of wired and mobile appliances, equipped with browsing, viewing, listening, filtering, managing, and other capabilities that are enabled as further discussed herein below.

The data sources 150 include multimedia content elements, and may further include metadata. The metadata may be related to sentiments expressed by viewers of the multimedia content elements and may include, but is not limited to, responses, view data (e.g., number of viewers, number of views, number of clicks, number of downloads, etc.), time indicators, combinations thereof, and the like. The responses may be in the form of, for example, explicit identifiers of approval and disapproval or interest and disinterest (e.g., “likes”, “dislikes”, “upvotes”, “downvotes”, etc.), comments, numbers of comments, rating values (e.g., numerical values on a scale of 1 to 10), combinations thereof, and the like. The comments may include, but are not limited to, text, multimedia content (e.g., emoji), combinations thereof, and the like. Each of the data sources 150 may be, for example, a web page, a website, an application, a social network platform, a blog, a chat, a news feed, a data repository, a database, and the like. In an example implementation, the data sources 150 include web sources available over the Internet.

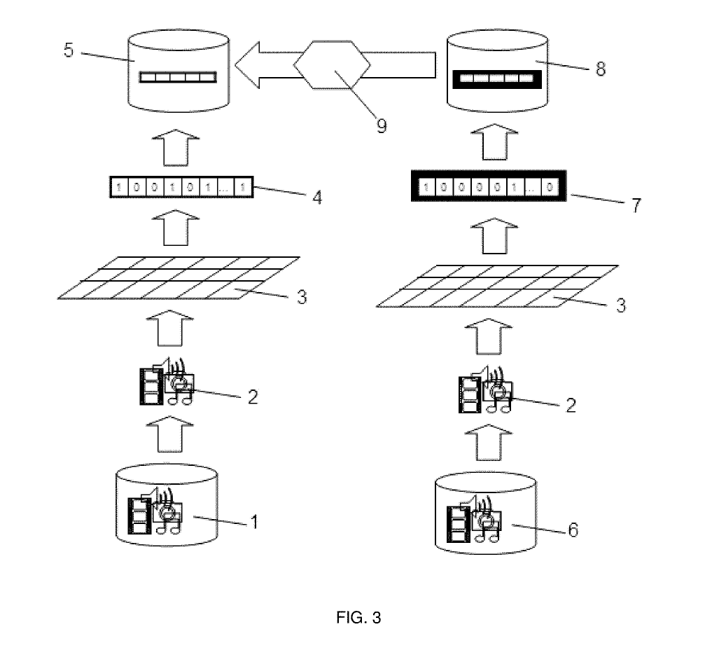

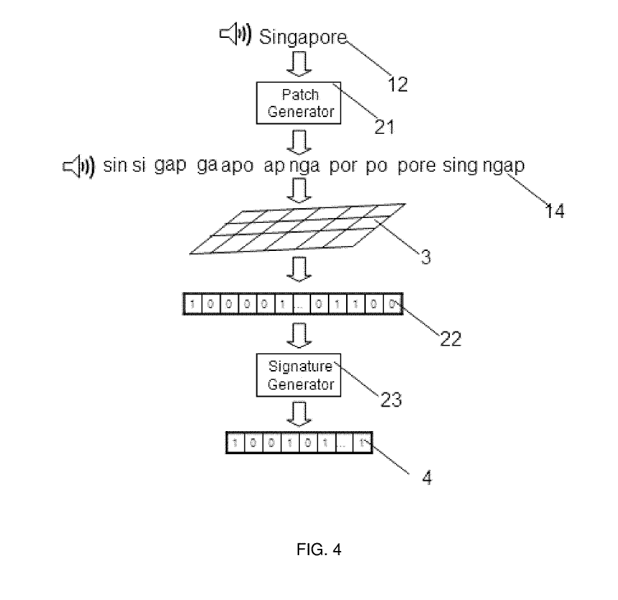

The various embodiments disclosed herein are realized using the recommendation generator 130 and a signature generator system (SGS) 140. The SGS 140 may be connected to the recommendation generator 130 directly or through the network 110. The recommendation generator 130 is enabled to receive and serve multimedia content elements and causes the SGS 140 to generate a signature respective of the multimedia content elements. The process for generating the signatures for the multimedia content elements is explained in greater detail herein below with respect to FIGS. 3 and 4.

In an embodiment, the recommendation generator 130 is configured to receive a query from the user device 120. The query may be a textual query, a graphical query (e.g., a multimedia content element), a combination thereof, and the like. A multimedia content element may include, for example, an image, a graphic, a video stream, a video clip, an audio stream, an audio clip, a video frame, a photograph, an image of signals (e.g., spectrograms, phasograms, scalograms, etc.), combinations thereof, portions thereof, and the like.

The query represents an intent of a user of the user device 120. The intent is a certain interest of a user at a certain time. In an example implementation, the intent may be indicated via one or more hash tags. The intent is utilized to identify content which may be of interest to the user. As a non-limiting example, a user searching for content related to the singer Beyoncé may enter the query “Beyonce” or “#beyonce” via the user device 120.

In an embodiment, based on the received query, the recommendation generator 130 is configured to search one or more of the plurality of data sources 150 for multimedia content elements that match the user's intent. The search may include, but is not limited to, comparing the received query to, for example, metadata, comments, or other data associated with multimedia content elements, wherein a multimedia content element matches the user's intent when the data associated with the multimedia content element matches the query above a predetermined threshold. In another embodiment, the search may include generating at least one signature to the received query (e.g., as described further herein below with respect to FIGS. 3 and 4), and comparing the generated at least one signature for the query to a plurality of signatures associated with multimedia content elements stored in the data sources 150. In a further embodiment, a multimedia content element may match the user intent when the at least one signature generated to the query matches a signature of the multimedia content element above a predetermined threshold.

In a further embodiment, the recommendation generator 130 may be configured to search for multimedia content elements that are trending, that were recently uploaded, or both. To this end, the search may be further based on metadata indicating whether multimedia content elements are trending, a time of upload of the multimedia content elements, or both. As a non-limiting example, if the query is “partying with friends”, multimedia content elements that are currently trending are searched through, for example, a plurality of social network websites such as, Instagram®, Facebook®, and the like, to find trending multimedia content elements (e.g., multimedia content elements including metadata indicating a trend) related to parties.

In an embodiment, the recommendation generator 130 is further configured to analyze the multimedia content elements found during the search, metadata associated with the found multimedia content elements, or both, to determine at least one context. The at least one context may be determined based on a plurality of signatures generated for each multimedia content element, based on a plurality of signatures generated for the found multimedia content elements, or both.

To this end, in a further embodiment, the recommendation generator 130 is configured to cause generation of at least one signature for each found multimedia content element. The generated signatures may be robust to noise and distortion as discussed herein below. In an embodiment, causing generation of the signatures for each multimedia content element may include, but is not limited to, sending each multimedia content element to the SGS 140 and receiving the signatures generated by the SGS 140. In another embodiment, the recommendation generator 130 may be configured to generate the at least one signature for each multimedia content element as described herein.

In yet a further embodiment, generating the at least one signature for a multimedia content element found during the search may further include causing generation of a plurality of signatures for metadata associated with the multimedia content element. As noted above, the metadata may be related to sentiments with respect to the multimedia content element and may include, but is not limited to, responses, view data, time indicators, combinations thereof, and the like. Generating a signature for such metadata may include, but is not limited to, generating a signature for multimedia content elements included in at least a portion of the metadata (e.g., text or images in comments related to the multimedia content element, text indicating numerical values representing numbers of views or likes, etc.).

Each signature generated for a multimedia content element represents a concept. A concept is a collection of signatures representing multimedia content elements and metadata describing the concept, and acts as an abstract description of the content to which the signature was generated. As an example, metadata of a concept represented by the signature generated for a picture showing a bouquet of red roses is “flowers”. As another example, metadata of a concept represented by the signature generated for a picture showing a bouquet of wilted roses is “wilted flowers”. According to these examples, a correlation between concepts can be achieved by probabilistic models to determine that the concept of “flowers” has a positive connotation in comparison to the concept “wilted flowers”. Moreover, the correlation between concepts can be achieved by identifying a ratio between signatures' sizes, a spatial location of each signature, and so on using the probabilistic models.

It should be noted that using signatures for determining the context ensures more accurate identification of trending multimedia content than, for example, based on metadata alone.

It should be noted that at least one signature may be generated for each portion of the metadata (e.g., each comment, each value included in the view data, each number of explicit approval or disapproval identifiers, each time indicator, and combinations thereof). Accordingly, signatures of a plurality of values for view data, comments, and the like, may represent a plurality of concepts. Accordingly, correlations among such concepts for a multimedia content element may be utilized to determine the degree to which a particular sentiment is related to the multimedia content element. For example, if the signatures show a high number of comments, the sentiment of the multimedia content element may be “popular.” More specifically, if the signatures show a high number of comments including positive language (e.g., “like,” “love,” “enjoy,” etc.), the sentiment of the multimedia content element may be “positive.”

In an embodiment, the recommendation generator 130 is configured to analyze the signatures generated to the found multimedia content elements to correlate between their respective concepts and to determine at least one context of such a correlation. Each context represents a sentiment with respect to the multimedia content element. In a further embodiment, the determined sentiment may be a positive, neutral, or negative sentiment; a popular or unpopular sentiment; or a combination thereof (e.g., indicating both whether the multimedia content element is popular and whether the response to the multimedia content element is, for example, good, bad, or indifferent).

As noted above, a strong context is determined when, e.g., there are at least a predetermined threshold number or proportion of concepts which satisfy the same predetermined condition. To this end, determining the context for a multimedia content element may include, but is not limited to, correlating among a plurality of signatures generated to metadata of the multimedia content element, or correlating between signatures generated to the multimedia content element itself (or portions thereof) with signatures generated to the other found multimedia content elements. As non-limiting examples, a strong positive context may be determined when at least 100 concepts represented by signatures generated to comments of a multimedia content element are related to a positive sentiment, when at least 60% of concepts represented by signatures generated to the comments of the multimedia content element are related to a negative sentiment, when concepts represented by signatures generated to at least 5000 multimedia content elements are correlated with a signature representing the multimedia content element, and the like.

In an embodiment, the recommendation generator 130 may be configured to generate a strength score for each determined context. The strength score indicates a relative strength of the context with respect to, e.g., other contexts, and may be utilized to rank multimedia content elements in order of trendiness (e.g., from high to low). The strength score may be generated based on, but not limited to, a number of correlated signatures related to a particular sentiment, a percentage of correlated signatures related to a particular sentiment, or both.

In an embodiment, the recommendation generator 130 is configured to store the determined contexts in, e.g., the database 160. In the embodiment illustrated in FIG. 1, the recommendation generator 130 communicates with the data warehouse 160 through the network 110. In other non-limiting configurations, the recommendation generator 130 is directly connected to the data warehouse 160

In a further embodiment, the recommendation generator 130 may be configured to generate and store a time indicator indicating the time of determination for the context. In yet a further embodiment, the recommendation generator 130 may be configured to track the trendiness of a multimedia content element over time based on the stored contexts and corresponding time indicators. For example, the overall sentiment associated with a multimedia content element may change from positive to negative or vice versa over time.

In an embodiment, based on the determined contexts, the recommendation engine 130 is configured to determine a sentiment associated with each found multimedia content element. In a further embodiment, the determined sentiment may be a sentiment represented by a strong context of the multimedia content element. For example, if a strong negative context and a weak (i.e., not strong) positive context are determined for the multimedia content element, the determined sentiment may be negative.

In an embodiment, based on the determined sentiments, the recommendation generator is configured to provide a recommendation of at least one multimedia content element to the user device 120. In a further embodiment, providing the recommendation may include sending each multimedia content element determined to have a particular sentiment (e.g., “positive,” “popular,” or “positive popular”), sending an indicator of a location (e.g., a URL or other location in storage) of each multimedia content element having a particular sentiment, and the like. As a non-limiting example, if the query of “playing soccer” is received, the recommendation may include images and videos showing people playing soccer for which positive sentiments are determined.

Following is a non-limiting example operation of the recommendation generator 130. An input query including the terms “drinking at the neighborhood Bar” is received. The recommendation generator 130 crawls through one or more of the data sources 160 in order to identify multimedia content elements containing content associated with drinking and neighborhood bars. Examples for such content include pictures of bars and restaurants, people drinking, and the like found by crawling through social media websites. The recommendation generator 130 generates at least one signature for each multimedia content element. As a particular example, a picture of a group of five people drinking beer is found.

In a first example implementation, the recommendation generator 130 generates one or more signatures representing the subject matter of the multimedia content element (e.g., signatures representing the people, the beers, or both) as well as signatures representing the subject matter of other found multimedia content elements. The signatures of the image showing the five people drinking beers are correlated with signatures representing the other found multimedia content elements. Based on the correlation, a context is determined that 6,000 of the signatures are correlated, which is above a threshold of 5,000 images. Based on the correlation, a “popular” sentiment is determined. Accordingly, the recommendation generator 130 generates a recommendation of the image of the five people drinking beers.

In a second example implementation, the recommendation generator 130 generates a plurality of signatures representing metadata of the image of the five people drinking beers. The metadata indicates that the image has received 10,000 “likes” of the image on social media and that there are 7,000 comments to the image including the word “love.” The signatures generated to the metadata are correlated to determine a context. Based on the context, a “positive” sentiment is determined. Accordingly, the recommendation generator 130 generates a recommendation of the image of the five people drinking beers.

It should be noted that the network diagram 100 shown in FIG. 1 is merely an example and does not limit the disclosed embodiments. Further, it should be noted that a single user device 120 is shown in FIG. 1 merely for simplicity purposes. Multiple user devices may be communicatively connected to the recommendation generator 130 without departing from the scope of the disclosure, and each may send queries and be provided with appropriate recommendations of trending content respective thereof.

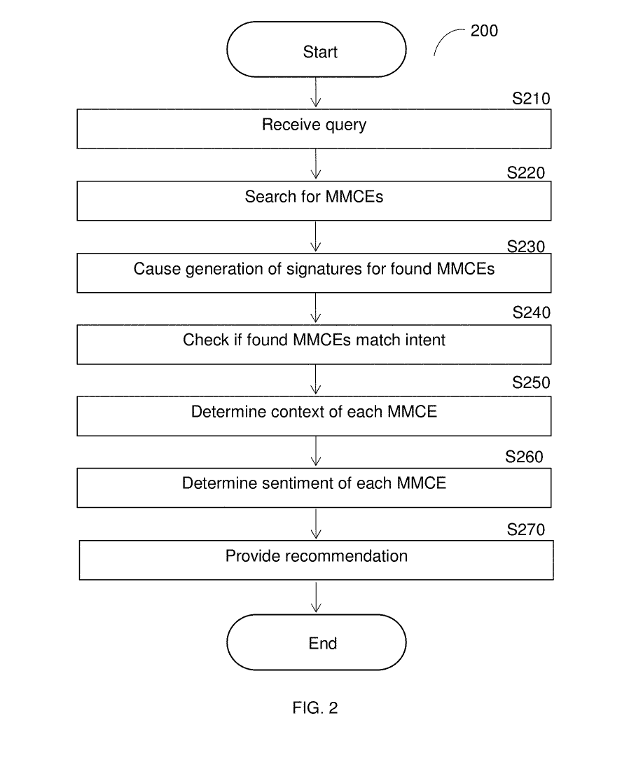

FIG. 2 is an example flowchart 200 describing a method for recommending trending content based on context according to an embodiment. In an embodiment, the method may be performed by the recommendation generator 130.

At S210, a query or a portion thereof is received from a user. The query represents a user intent. The query may include, but is not limited to, text, multimedia content elements, combinations thereof, and the like. A multimedia content element may be, for example, an image, a graphic, a video stream, a video clip, an audio stream, an audio clip, a video frame, a photograph, an image of signals, combinations thereof, and portions thereof.

At S220, based on the query, multimedia content elements are searched for. In an embodiment, the search may be performed by crawling through one or more data sources (e.g., the data sources 160, FIG. 1) to identify the existence of multimedia content elements that relate to the query, for example, multimedia content elements associated with metadata (e.g., comments, tags, etc.) related to the received query. As a non-limiting example, the crawling may be performed through social media networks, web sites, blogs, news feeds, multimedia channels, or any platform in which multimedia content elements associated with the intent may be available. In an embodiment, S220 includes obtaining the found multimedia content elements. In a further embodiment, S220 may include obtaining metadata associated with the found multimedia content elements.

At S230, at least one signature is caused to be generated for each multimedia content element found during the search. The signatures are generated as described further herein below with respect to FIGS. 3 and 4. In an embodiment, S230 includes sending, to a signature generator system, the found multimedia content elements, and receiving, from the signature generator system, the signatures generated for each of the multimedia content elements. In another embodiment, S230 may include generating the signatures for each found multimedia content element.

In an embodiment, the signatures generated for each multimedia content element include a signature generated to the multimedia content element or each portion thereof. In another embodiment, the signatures generated for each multimedia content element include a plurality of signatures generated to metadata of the multimedia content elements. The metadata may include, but is not limited to, responses, view data (e.g., number of viewers, number of views, number of clicks, number of downloads, etc.), time indicators, combinations thereof, and the like. The responses may be in the form of, for example, explicit identifiers of approval and disapproval or interest and disinterest (e.g., “likes”, “dislikes”, “upvotes”, “downvotes”, etc.), comments, numbers of comments, rating values (e.g., numerical values on a scale of 1 to 10), combinations thereof, and the like. The comments may include, but are not limited to, text, multimedia content (e.g., emoji), combinations thereof, and the like.

At optional S240, it may be checked if each of the multimedia content elements found during the search is related to the user intent. In an embodiment, S240 may include generating at least one signature for the received query and comparing the at least one signature generated for the query to the signatures generated for each multimedia content element. In a further embodiment, each multimedia content element having signatures that match signatures of the query above a predetermined threshold may be determined as related to the user intent.

The checking of S240 may be utilized to filter multimedia content elements found during the search to remove multimedia content elements that are not sufficiently related to the user intent, as signature-based matching may result in more accurate identification of relevant content than, for example, comparing text of a query to metadata.

At S250, each found multimedia content element is analyzed to determine at least one context. In an optional embodiment, contexts are only determined for found multimedia content elements that are related to the user intent as determined in S240. Each context represents a sentiment of the corresponding multimedia content element.

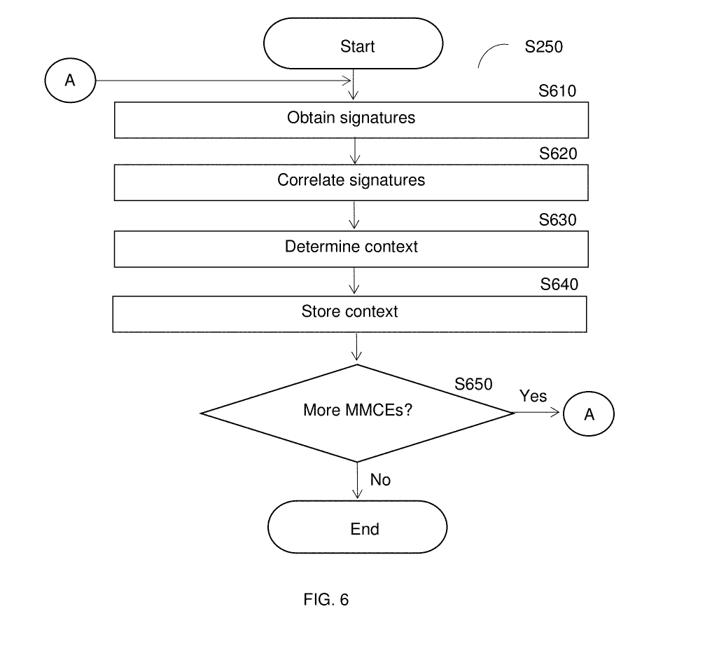

In an embodiment, determining the context for a multimedia content element includes correlating among the plurality of signatures generated for the metadata of the multimedia content element. In another embodiment, determining the context may include correlating among signatures generated for a plurality of the found multimedia content elements. The correlation can be performed using probabilistic models. Determining contexts for multimedia content elements is described further herein below with respect to FIG. 6.

At S260, based on the determined contexts, a sentiment value of each analyzed multimedia content element is determined. In an embodiment, S260 includes identifying a strong context with respect to a certain sentiment value (e.g., positive, neutral, or negative; popular or unpopular; etc.) by checking if a predetermined threshold (e.g., a threshold number or proportion) of concepts satisfy the same predetermined condition. In an embodiment, the predetermined condition is set with respect to a certain sentiment value. For example, if 70% of the concepts represented by signatures generated for metadata of the multimedia content element can be considered as trending towards a positive sentiment, then a strong context of positive sentiment may be identified. In another embodiment, the predetermined condition is set with respect to a volume of similar multimedia content elements. For example, if signatures of at least 5000 other multimedia content elements are correlated to at least one signature generated for a multimedia content element, a strong context of popular sentiment may be identified.

In a further embodiment, S260 further includes obtaining the plurality of sentiment signatures representing indicators of sentiments. The indicators may be predetermined indicators of known sentiments. Example sentiments may include, but are not limited to, a positive sentiment, a neutral sentiment, or a negative sentiment; popular or unpopular; a combination thereof; and the like. Each sentiment indicator signature may be generated to a predetermined indicator of a known sentiment. In a further embodiment, the sentiment indicator signatures may include signatures generated to responses such as, but not limited to, sentiment-related language (e.g., “love,” “like,” “hate,” “dislike,” “meh,” “yay,” “enjoy,” etc.), emoji (e.g., smiley face, frowny face, thumbs up, thumbs down, etc.), view data (e.g., high numbers of likes or upvotes, high numbers of dislikes, etc.), numbers of comments, number of clicks, number of downloads, time pointers associated therewith, combinations thereof, and the like. In yet a further embodiment, S260 includes comparing the correlated signatures of each determined context to the obtained sentiment signatures and determining, based on the comparison, a sentiment for each context. For example, if correlated signatures of a context match a sentiment signature representing a positive sentiment above a predetermined threshold, the sentiment for the context may be determined as positive.

At S270, based on the determined sentiment values, a recommendation of at least one multimedia content element is provided. Providing the recommendation may include, but is not limited to, sending (e.g., to a user device) at least one recommended multimedia content element or at least one pointer (e.g., a URL or a pointer to a location in storage) of the at least one recommended multimedia content element. The at least one recommended multimedia content element may include each analyzed multimedia content element having a sentiment value matching a predetermined recommended sentiment value. In an example implementation, the recommended sentiment values may include a positive sentiment, a popular sentiment, or both. For example, the at least one recommended multimedia content element for a query “Jerry Seinfeld standup” may include only multimedia content elements having a sentiment value indicating a positive sentiment, a popular sentiment, or a positive popular sentiment.

FIGS. 3 and 4 illustrate the generation of signatures for the multimedia content elements by the SGS 140 according to one embodiment. An exemplary high-level description of the process for large scale matching is depicted in FIG. 3. In this example, the matching is for a video content.

Video content segments 2 from a Master database (DB) 6 and a Target DB 1 are processed in parallel by a large number of independent computational Cores 3 that constitute an architecture for generating the Signatures (hereinafter the “Architecture”). Further details on the computational Cores generation are provided below. The independent Cores 3 generate a database of Robust Signatures and Signatures 4 for Target content-segments 5 and a database of Robust Signatures and Signatures 7 for Master content-segments 8. An exemplary and non-limiting process of signature generation for an audio component is shown in detail in FIG. 4. Finally, Target Robust Signatures and/or Signatures are effectively matched, by a matching algorithm 9, to Master Robust Signatures and/or Signatures database to find all matches between the two databases.

To demonstrate an example of the signature generation process, it is assumed, merely for the sake of simplicity and without limitation on the generality of the disclosed embodiments, that the signatures are based on a single frame, leading to certain simplification of the computational cores generation. The Matching System is extensible for signatures generation capturing the dynamics in-between the frames.

The Signatures' generation process is now described with reference to FIG. 4. The first step in the process of signatures generation from a given speech-segment is to breakdown the speech-segment to K patches 14 of random length P and random position within the speech segment 12. The breakdown is performed by the patch generator component 21. The value of the number of patches K, random length P and random position parameters is determined based on optimization, considering the tradeoff between accuracy rate and the number of fast matches required in the flow process of the recommendation generator 130 and SGS 140. Thereafter, all the K patches are injected in parallel into all computational Cores 3 to generate K response vectors 22, which are fed into a signature generator system 23 to produce a database of Robust Signatures and Signatures 4.

In order to generate Robust Signatures, i.e., Signatures that are robust to additive noise L (where L is an integer equal to or greater than 1) by the Computational Cores 3 a frame ‘i’ is injected into all the Cores 3. Then, Cores 3 generate two binary response vectors: \vec{S} which is a Signature vector, and \vec{RS} which is a Robust Signature vector.

For generation of signatures robust to additive noise, such as White-Gaussian-Noise, scratch, etc., but not robust to distortions, such as crop, shift and rotation, etc., a core Ci={ni} (1≦i≦L) may consist of a single leaky integrate-to-threshold unit (LTU) node or more nodes. The node ni equations are:

$${V}_{i} = {\sum }_{j} {w}_{ij} {k}_{j}$$

$$ni = θ ( Vi - Thx )$$

where, θ is a Heaviside step function; wij is a coupling node unit (CNU) between node i and image component j (for example, grayscale value of a certain pixel j); kj is an image component ‘j’ (for example, grayscale value of a certain pixel j); ThX is a constant Threshold value, where ‘x’ is ‘S’ for Signature and ‘RS’ for Robust Signature; and Vi is a Coupling Node Value.

The Threshold values ThX are set differently for Signature generation and for Robust Signature generation. For example, for a certain distribution of Vi values (for the set of nodes), the thresholds for Signature (ThS) and Robust Signature (ThRS) are set apart, after optimization, according to at least one or more of the following criteria:

1: For: Vᵢ>Th_{RS}

1−p(V>Th_{S})−1−(1−ε)^{l}<<1

i.e., given that I nodes (cores) constitute a Robust Signature of a certain image I, the probability that not all of these I nodes will belong to the Signature of same, but noisy image, Ĩ is sufficiently low (according to a system's specified accuracy).

_{2:} p(Vᵢ>Th_{RS})≈l/L i.e., approximately I out of the total L nodes can be found to generate a Robust Signature according to the above definition.

3: Both Robust Signature and Signature are generated for certain frame i.

It should be understood that the generation of a signature is unidirectional, and typically yields lossless compression, where the characteristics of the compressed data are maintained but the uncompressed data cannot be reconstructed. Therefore, a signature can be used for the purpose of comparison to another signature without the need of comparison to the original data. The detailed description of the Signature generation can be found in U.S. Pat. Nos. 8,326,775 and 8,312,031, assigned to the common assignee, which are hereby incorporated by reference for all the useful information they contain.

A Computational Core generation is a process of definition, selection, and tuning of the parameters of the cores for a certain realization in a specific system and application. The process is based on several design considerations, such as:

(a) The Cores should be designed so as to obtain maximal independence, i.e., the projection from a signal space should generate a maximal pair-wise distance between any two cores' projections into a high-dimensional space.

(b) The Cores should be optimally designed for the type of signals, i.e., the Cores should be maximally sensitive to the spatio-temporal structure of the injected signal, for example, and in particular, sensitive to local correlations in time and space. Thus, in some cases a core represents a dynamic system, such as in state space, phase space, edge of chaos, etc., which is uniquely used herein to exploit their maximal computational power.

(c) The Cores should be optimally designed with regard to invariance to a set of signal distortions, of interest in relevant applications.

A detailed description of the Computational Core generation and the process for configuring such cores is discussed in more detail in the above-mentioned U.S. Pat. No. 8,655,801.

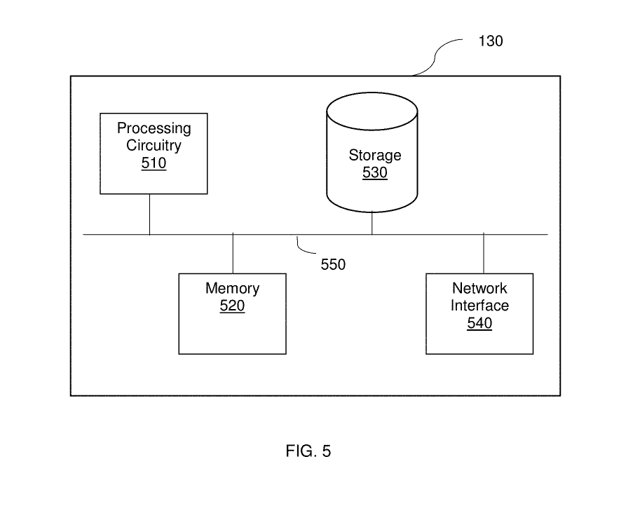

FIG. 5 is an example block diagram of the trending content recommendation generator 130 according to an embodiment. The trending content recommendation generator 130 includes a processing circuitry 510 coupled to a memory 520, a storage 530, and a network interface 540. In an embodiment, the components of the trending content recommendation generator 130 may be communicatively connected via a bus 550.

The processing circuitry 510 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information. In an embodiment, the processing circuitry 510 may be realized as an array of at least partially statistically independent computational cores. The properties of each computational core are set independently of those of each other core, as described further herein above.

The memory 520 may be volatile (e.g., RAM, etc.), non-volatile (e.g., ROM, flash memory, etc.), or a combination thereof. In one configuration, computer readable instructions to implement one or more embodiments disclosed herein may be stored in the storage 530.

In another embodiment, the memory 520 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 510, cause the processing circuitry 510 to perform the various processes described herein. Specifically, the instructions, when executed, cause the processing circuitry 510 to provide recommendations of trending content based on context as described herein.

The storage 530 may be magnetic storage, optical storage, and the like, and may be realized, for example, as flash memory or other memory technology, CD-ROM, Digital Versatile Disks (DVDs), or any other medium which can be used to store the desired information.

The network interface 540 allows the trending content recommendation generator 130 to communicate with the signature generator system 140 for the purpose of, for example, sending multimedia content elements, receiving signatures, and the like. Further, the network interface 540 allows the trending content recommendation generator to communicate with the user device 120 for the purpose of, for example, receiving queries, sending recommendations of content, and the like. Additionally, the network interface 540 allows the trending content recommendation generator 130 to communicate with the data sources 170 in order to search for multimedia content elements.

It should be understood that the embodiments described herein are not limited to the specific architecture illustrated in FIG. 5, and other architectures may be equally used without departing from the scope of the disclosed embodiments. In particular, the trending content recommendation generator 130 may further include a signature generator system configured to generate signatures as described herein without departing from the scope of the disclosed embodiments.

FIG. 6 is an example flowchart S250 illustrating a method for determining contexts of multimedia content elements according to an embodiment.

At optional S610, a plurality of signatures generated to at least one multimedia content element is obtained. The obtained signatures may be, but are not limited to, retrieved from a storage (e.g., the database 160, FIG. 1). The generated signatures are robust to noise and distortion, and are generated as described in greater detail herein above with respect to FIGS. 3 and 4. It should be noted that a signature can be generated for a portion of a multimedia content element, or for a whole multimedia content element.

In an embodiment, obtained signatures include at least one of: signatures generated to a plurality of multimedia content elements (i.e., signatures representing concepts of the multimedia content elements), signatures generated to metadata of the at least one multimedia content element, or both. The metadata may indicate sentiments and may include, but is not limited to, view data (e.g., numbers of views), responses (e.g., comments, “likes,” etc.), and the like. As non-limiting examples, for an image of a lion posted on a social media website, a signature may be generated for at least one of: the lion image, a portion of the lion image, tags for the image including the text “lion show at the zoo,” a comment to the posting of the lion image including the text “I love lions!,” a number representing a number of views of the image, and a number indicating the number of “likes” or “upvotes” of the image. Accordingly, the signatures may further represent information related to trendiness of the multimedia content elements.

At S620, correlations between the generated signatures, or portions thereof, are determined. Specifically, each signature represents a different concept. The signatures are analyzed to determine the correlations of concepts. A concept is an abstract description of the content to which the signature was generated. For example, a concept of the signature generated for a picture showing a bouquet of red roses is “flowers”. The correlation between concepts can be achieved by identifying a ratio between signatures' sizes, a spatial location of each signature, and the like, using probabilistic models. As noted above, a signature represents a concept and is generated for a multimedia content element. Thus, identifying, for example, the ratio of signatures' sizes may also indicate the ratio between the sizes of their respective multimedia elements.

In an embodiment, one or more typically probabilistic models may be utilized to determine the correlation between signatures representing concepts. Use of the probabilistic models may result in, for example, the probability that a signature may appear in the same orientation and in the same ratio as another signature. When performing the analysis, information such as, for example, previously analyzed signatures, may be utilized.

At S630, based on the correlation of signatures, a context is determined for the at least one multimedia content element. The determined context represents a sentiment. A context is determined as the correlation between a plurality of concepts. A strong context is determined when there are more concepts, or a plurality of concepts, that satisfy the same predetermined condition. As an example, if comments for a video include a high number of comments (e.g., a number above a predetermined threshold or a percentage of comments above a predetermined threshold) indicating positive sentiments (for example, comments including the words “like” or “love”), a strong context representing a positive popular sentiment may be determined. As another example, if signatures representing the respective contents of a threshold number of multimedia content elements or portions thereof are correlated, a strong context representing a popular sentiment may be determined.

As a non-limiting example, a plurality of signatures generated for a cat video is obtained. The signatures include signatures representing metadata indicating that the video has received 5,000,000 likes on YouTube® and text included in comments associated with the video featuring 2,000,000 comments featuring the word “great.” The signatures representing the likes and the “great” comments are correlated to determine a context representing a positive sentiment. A strong context is determined based on the 7,000,000 total signatures that were correlated being above a threshold number of signatures.

At optional S640, the determined context may be stored in a database for future use. The stored context may further be stored along with a time indicator, thereby allowing for analyzing changes in sentiment over time. For example, a sentiment of a multimedia content element may change from a positive sentiment to a negative sentiment over time (e.g., a viral video may become less popular over time).

At S650, it is checked if contexts for additional multimedia content elements are needed and, if so, execution continues with S210; otherwise execution terminates. It should be noted that, although the embodiment shown in FIG. 6 is described with respect to determining contexts for multiple multimedia content elements in series, such contexts may be equally determined in parallel without departing from the scope of the disclosure.

Determining contexts for multimedia content elements is described further in the above-noted U.S. patent application Ser. No. 13/770,603, assigned to the common assignee.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for recommending trending content based on context, comprising:
receiving a query, wherein the query indicates a user intent;
searching in at least one data source for a plurality of multimedia content elements related to the user intent;
generating at least one signature for each of the plurality of multimedia content elements, wherein each signature represents a concept, wherein each concept is a collection of signatures and metadata describing the concept;
correlating the concepts of the generated signatures to determine at least one context of each multimedia content element, wherein each context represents a sentiment; and
generating, based on the determined contexts, a recommendation of at least one multimedia content element from among the plurality of multimedia content elements.

2. The method of claim 1, wherein generating the at least one signature for each multimedia content element related to the user intent further comprises:
generating a plurality of signatures to metadata associated with the multimedia content element, wherein the concepts are correlated among the plurality of signatures generated to the metadata of each multimedia content element.

3. The method of claim 2, wherein the metadata includes at least one of: a number of likes, a number of dislikes, a number of upvotes, a number of downvotes, at least one comment, a number of comments, at least one rating value, a number of viewers, a number of views, a number of clicks, and a number of downloads.

4. The method of claim 1, wherein generating the at least one signature for each multimedia content element related to the user intent further comprises:
generating a signature to the multimedia content element, wherein the concepts are correlated between signatures generated to the plurality of multimedia content elements.

5. The method of claim 1, further comprising:
determining, based on the at least one context of each multimedia content element, a sentiment value of each multimedia content element, wherein each recommended multimedia content element has a sentiment value matching a predetermined recommended sentiment value.

6. The method of claim 5, further comprising:
identifying, based on the correlation, a strong context of each multimedia content element, wherein the sentiment value for each multimedia content element is determined based further on the identified strong context for the multimedia content element.

7. The method of claim 6, wherein a context is identified as a strong context when a predetermined threshold of concept correlated to determine the context each satisfy a predetermined condition.

8. The method of claim 1, wherein each signature is robust to noise and distortions.

9. The method of claim 1, wherein each signature is generated by a signature generator system, wherein the signature generator system includes a plurality of computational cores configured to receive a plurality of unstructured data elements, each computational core of the plurality of computational cores having properties that are at least partly statistically independent of other of the computational cores, wherein the properties of each core are set independently of each other core.

10. A non-transitory computer readable medium having stored thereon instructions for causing a processing circuitry to perform a process, the process comprising:
receiving a query, wherein the query indicates a user intent;
searching in at least one data source for a plurality of multimedia content elements related to the user intent;
generating at least one signature for each of the plurality of multimedia content elements, wherein each signature represents a concept, wherein each concept is a collection of signatures and metadata describing the concept;
correlating the concepts of the generated signatures to determine at least one context of each multimedia content element, wherein each context represents a sentiment; and
generating, based on the determined contexts, a recommendation of at least one multimedia content element from among the plurality of multimedia content elements.

11. A system for recommending trending content based on context, comprising:
a processing circuitry; and
a memory, the memory containing instructions that, when executed by the processing circuitry, configure the processing circuitry to:
receive a query, wherein the query indicates a user intent;
search in at least one data source for a plurality of multimedia content elements related to the user intent;
generate at least one signature for each of the plurality of multimedia content elements, wherein each signature represents a concept, wherein each concept is a collection of signatures and metadata describing the concept;
correlate the concepts of the generated signatures to determine at least one context of each multimedia content element, wherein each context represents a sentiment; and
generate, based on the determined contexts, a recommendation of at least one multimedia content element from among the plurality of multimedia content elements.

12. The system of claim 11, wherein the system is further configured to:
generate a plurality of signatures to metadata associated with the multimedia content element, wherein the concepts are correlated among the plurality of signatures generated to the metadata of each multimedia content element.

13. The system of claim 12, wherein the metadata includes at least one of: a number of likes, a number of dislikes, a number of upvotes, a number of downvotes, at least one comment, a number of comments, at least one rating value, a number of viewers, a number of views, a number of clicks, and a number of downloads.

14. The system of claim 11, wherein the system is further configured to:
generate a signature to the multimedia content element, wherein the concepts are correlated between signatures generated to the plurality of multimedia content elements.

15. The system of claim 11, wherein the system is further configured to:
determine, based on the at least one context of each multimedia content element, a sentiment value of each multimedia content element, wherein each recommended multimedia content element has a sentiment value matching a predetermined recommended sentiment value.

16. The system of claim 15, wherein the system is further configured to:
identify, based on the correlation, a strong context of each multimedia content element, wherein the sentiment value for each multimedia content element is determined based further on the identified strong context for the multimedia content element.

17. The system of claim 16, wherein a context is identified as a strong context when a predetermined threshold of concept correlated to determine the context each satisfy a predetermined condition.

18. The system of claim 11, wherein each signature is robust to noise and distortions.

19. The system of claim 1, further comprising:
a signature generator system, wherein each signature is generated by the signature generator system, wherein the signature generator system includes a plurality of computational cores configured to receive a plurality of unstructured data elements, each computational core of the plurality of computational cores having properties that are at least partly statistically independent of other of the computational cores, wherein the properties of each core are set independently of each other core.
